(19) United States
(12) Patent Application Publication
(10) Pub. No.: US 2001/0053234 A1
(43) Pub. Date: Dec. 20, 2001

(54) Media commerce system employing watermarks

(76) Inventor: Geoffrey B. Rhoads, West Linn, OR (US)

Correspondence Address: DIGIMARC CORPORATION, 19801 SW 72ND AVENUE, SUITE 100, TUALATIN, OR, 97062, US

(21) Appl. No.: 09/804,679

(22) Filed: Mar. 12, 2001

Related U.S. Application Data
(62) Division of application No. 09/337,590, filed on Jun. 21, 1999.
(60) Provisional application No. 60/134,782, filed on May 19, 1999.

(51) Int. Cl. H04K 1/00; H04L 9/00; G06F 17/60; G06K 9/00

(52) U.S. Cl. 382/100; 705/52

(57) ABSTRACT

A long pseudo-random binary number, such as 128 bits, is used to represent a small increment of money (e.g., a penny, a nickel, a dime, a quarter, etc.). The long length and random character of the number essentially makes each number unique. These numbers are issued by banks or other institutions in exchange for other forms of money (e.g., cash, check, credit card, or other electronic money). The bank tracks the numbers it has issued. A consumer can transmit one or more of these numbers to a vendor to pay for goods or services. The vendor relays the numbers to a server computer (e.g., at the issuing institution, as may be indicated by a bit string appended to each binary number) to determine whether such numbers have been validly issued. If the server confirms they are valid, it informs the vendor, who then completes the transaction. The vendor's account is credited by the institution accordingly. The server marks these numbers as spent, so that if these same numbers are later presented to the server, they will not be honored as valid numbers. The long lengths of the bit strings makes hacking impractical. The system can be arranged to provide anonymity since there is no need to identify the customer in order for the merchant to redeem the tokens.

### RELATED APPLICATION DATA

This application is a division of application Ser. No. 09/337,590, filed Jun. 21, 1999, which is a continuation-in-part of provisional application Ser. No. 60/134,782, filed May 19, 1999.

### FIELD OF THE INVENTION

The present invention relates to on-line payments and systems in which money is represented digitally.

### BACKGROUND AND SUMMARY OF THE INVENTION

With the explosive growth of the internet, a variety of electronic monies have been proposed. Most employ sophisticated encryption or other security technologies.

The complexity of such prior art digital money systems is warranted in certain instances, but in other instances poses an unnecessary obstacle to widespread implementation.

In accordance with a preferred embodiment of the present invention, a long pseudo-random binary number, such as 128 bits, is used to represent a small increment of money (e.g., a penny, a nickel, a dime, a quarter, etc.). The long length and random character of the number essentially makes each number unique. These numbers are issued by banks or other institutions in exchange for other forms of money (e.g., cash, check, credit card, or other electronic money). The bank tracks the numbers it has issued.

A consumer can transmit one or more of these numbers to a vendor to pay for goods or services. The vendor relays the numbers to a server computer (e.g., at the issuing institution, as may be indicated by a bit string appended to each binary number) to determine whether such numbers have been validly issued. If the server confirms they are valid, it informs the vendor, who then completes the transaction. The vendor's account is credited by the institution accordingly. The server marks these numbers as spent, so that if these same numbers are later presented to the server, they will not be honored as valid numbers.

The long lengths of the bit strings makes hacking impractical. The system can be arranged to provide anonymity since there is no need to identify the customer in order for the merchant to redeem the tokens.

The foregoing and additional features and advantages will be more readily apparent from the following description.

### DETAILED DESCRIPTION

In an exemplary embodiment, a token comprises a 128-bit pseudo-random number to which additional bits identifying an issuing bank (or other issuing institution) are appended. (The additional bits can be the IP address of a web server of the bank, a routing number identifying the bank for electronic wire transfers, or other identifier.) The 128-bit numbers are randomly generated by the bank—commonly as needed—and each represents a fixed increment of money, e.g. ten cents.

A consumer wishing to have a store of currency for such commerce pays the bank, e.g., $10 in exchange for 100 tokens. These tokens are transferred electronically to disk or other storage in the consumer's computer in response, e.g., to a credit card authorization, or may be provided by diskette or other storage medium over the counter at a bank branch (in which case the consumer thereafter copies the numbers into storage of his or her computer). (Outlets other than banks can of course be employed for distributing such numbers, much in the manner that convenience and many grocery stores commonly issue money orders.) The issuing institution makes a record of the numbers that have been validly issued.

Imagine that the consumer wishes to view the final quarter of a Trailblazer basketball game that aired on television a week ago. (The consumer may have either missed the game, or may have seen it but wants to see the last quarter again.) The user directs an internet web browser to a web site maintained for such purpose and performs a search to identify the desired program. (Typically, the web site is maintained by the proprietor that holds the copyright in the material, but this need not be the case. Some material may be available at several web sites, e.g., maintained by ABC Sports, the National Basketball Association, and Sports Illustrated.) The search can use any of various known search engines, e.g., Infoseek, Verity, etc., and can permit searching by title terms, keywords, date of airing, copyright owner, etc. By typing in, e.g., the keyword ‘Trailblazers’ and the date ‘Apr. 26, 1999,’ the consumer is presented a listing of videos available for download. One, hopefully, is the requested game. With each listing is an indication of an associated nominal charge (e.g. 80 cents).

On clicking on a hypertext link associated with the desired basketball game, the viewer is presented a further screen with one or more options. The first of the listed options is the entire game, with commercials. The charge is the nominal charge presented on the earlier screen (i.e. 80 cents). Other options may include the first, second, third, and fourth quarters of the game individually, each of which—save the last, costs 20 cents. The last may be charged at a premium rate, e.g., 30 cents. Clicking on the desired video option yields a further screen through which payment is effected.

To pay for the requested video, the consumer instructs his or her computer to transfer three of the earlier-purchased tokens over the web to the video provider. Various user interface metaphors can be employed to facilitate this transfer, e.g., permitting the user to type the amount of money to be transferred in a dialog box presented on-screen, or dropping/dragging icons representing tokens (coins) from an on-screen “wallet” to an on-screen “ticket booth” (or over an icon or thumbnail representing the desired content), clicking on an “increment” counter displayed adjacent the listing of the content, etc. Once the consumer has authorized a transfer of sufficient tokens, the consumer's computer sends to the web site (or to such other web address as HTML encoding in the viewed web page may indicate) the tokens. This transmission simply takes the form of the three 128+ bit numbers (the ‘+’ indicating the bank identifier)—in whatever packet or other format may be used by the internet link. Once dispatched in this manner, the tokens are deleted from the user's computer, or simply marked as spent. (Of course, in other embodiments, a record of the expenditure may be stored in the consumer's computer, e.g., with the token contents and a record of the audio or video purchase to which they were applied.)

Since the amount of money is nominal, no encryption is provided in this embodiment, although encryption can naturally be provided in other embodiments (e.g., either in sending the tokens from the user to the web site, or earlier, in sending the tokens to the user). As will be seen, provided that the media provider immediately sends the tokens to the bank in real time, encryption is a nice feature but not mandatory

On receipt of the token data, the web site immediately routes the token data to the identified bank, together with an identifier of the media provider or account to which the funds represented thereby are to be credited. The bank checks whether the 128-bit numbers have been issued by that bank, and whether they have already been spent. If the numbers are valid, the bank updates its disk-based records to indicate that the three tokens have been spent and that the bank now owes the media supplier 30 cents, which it may either pay immediately (e.g., by crediting to an account identified by the media provider) or as one lump sum at the end of the month. The bank then sends a message to the web site confirming that the tokens were valid and credited to the requested account. (Optionally, a message can be sent to the purchaser of the tokens (if known), reporting that the tokens have been redeemed.)

In response, the web site begins delivery of the requested video to the consumer. In the illustrated embodiment, the video is watermarked prior to delivery, but otherwise sent in unencrypted fashion, typically in streaming format, but optionally in file format. (Encryption can be used in other embodiments.) The watermarking in the illustrated embodiment is accomplished on-the-fly and can include various data, including the date of downloading, the download site, the destination IP address, the identity of the purchaser (if known), etc. The watermarking can be accomplished in the spatial domain, the DCT domain, or another domain. (The reader is presumed to be familiar with the digital watermarking literature, so such details are not further belabored.)

The large size of the video and the small charge assessed therefor provide disincentives for the consumer making illicit copies. (Especially as to archival material whose value decays with time, there is not much after-market demand that could be served by illicit copies, making third party compilation of such material for re-distribution financially unattractive. First run video, and material that keeps a high value over time, would not be as well suited for such distribution, and could better employ other of the assignee's technology.)

In the illustrative system, nothing in the tokens indicates the identity of the purchaser. The web site knows the IP address of the site to which video was delivered, but need not otherwise know the identity of the purchaser. The bank would probably maintain a record of who purchased the tokens, but need not. In any event, such tokens could thereafter be exchanged among consumers, resulting in anonymity from the bank, if desired.

As described above, the video excerpts from which the consumer can select include commercials. At some sites, video may be provided from which the commercials have been excised, or which is delivered in a manner that skips past the commercials without transmitting same to the consumer. Such video will naturally command a premium price. In some embodiments, the difference in price is electronically credited as compensation to accounts maintained for (or by) the advertisers, whose advertisements are not being viewed by such consumers. (The identification of advertisers to be credited is desirably permanently encoded in the video, either throughout the video (if the video has had the commercials removed therefrom), or by data in the commercials themselves (which commercials are skipped for transmission to the consumer, but can still be decoded at the video head-end. Such encoding can be by in-band watermarking or otherwise.)

While the foregoing discussion particularly considered video as the desired content, the same principles are equally applicable in connection with audio, still imagery, and other content.

The token-based payment method is but one of many that can be employed; the literature relating to on-line payment mechanisms is extensive, and all such systems can generally be here-employed.

Tracking 128-bit tokens can be a logistical problem for the bank. One approach is to have a memory with 10¹²⁸ locations, and at each location store a two-bit value (e.g. 00=never issued; 01=issued but not spent; 10=issued and spent; 11=reserved). More complete data could alternatively be stored, but such a memory would be impractically large.

One alternative approach is to hash each 128-bit number, when issued, to a much smaller key value (e.g. 20 bits). A memory with 10²⁰ locations can be indexed by this key. Each such location can include four data: an issued 128-bit token number that hashes to that value, first and second date fields indicating the date/time on which that token was issued and redeemed, respectively, and a link specifying the address of a next memory location. That next memory location (outside of the original 10²⁰ locations) can include four more data, this time for a second issued-128-bit token number that hashed to the original key value, two date fields, and again with a link to a subsequent storage location, etc.

When a 128-bit random number is generated, the original memory location indexed by the hash code of that number is checked for an earlier number of the identical value (to avoid issuance of duplicate tokens). Each successive location in the linked chain of memory locations is checked for the same 128-bit number. When the end of the linked chain is reached, the bank knows that the 128-bit random number has not previously been issued, and writes that number in the last-addressed location, together with the date of issuance, and a link to a next storage location.

When a 128-bit token is received, the same linked-list processing occurs to identify a first location, and to thereafter step through each subsequent location until a match is found between the token number and the number stored in one of the linked memory locations. When found, that number is marked as redeemed by writing a redemption date/time in the corresponding field. If the search reaches the end of the linked chain without finding a match between the stored numbers and the token number, the token is treated as invalid (i.e. not issued by that bank).

Other manners of tracking the large number of possible token numbers can of course be used; the foregoing is just exemplary. Or the tokens needn't be tracked at all. Such an arrangement is highly practical if the token has sufficient bits. With the illustrated 128 bits, for example, the chance of two identical tokens being issued is infinitesimally small, so checking for duplicate issuance can be omitted if desired. In such case, the bank can simply maintain an ordered list of the token numbers still outstanding and valid. As new tokens are dispensed, their token numbers are added to the list. As tokens are redeemed, their numbers are deleted from the list. Known list processing techniques can be employed to speed such search, update, and delete actions.

The foregoing description of tokens (which may take the form of desktop coin icons) and their underlying 128 random binary strings can be generalized along the following lines.

Party A creates a secret, any secret. Party A “issues” the secret to party B in exchange for one dime, where party A promises to redeem that dime to whomever presents the secret back to party A. That secret, between the time of its issuance and the time of its redemption, becomes a virtual dime. The first party to redeem the secret gets the dime. Thereafter, the secret is worthless.

This simple arrangement is what applicant refers to as the “first to redeem” cash system. The simple ideas behind the notion include:

a) it is straightforward to create a secret system whereby Party A can create a secret that no third party can duplicate to their economic advantage

b) ascribing low value units to individual secrets, and distributing many secrets for large value holdings, can remove any economic advantages to third party's attempting to systematically stealing secrets in any kind of large-scale fashion

c) as with physical currency, common sense dictates that holders of secrets maintain basic safeguards against non-trusted third parties discovering or stealing those secrets for redemption.

d) by concentrating purchasing transactions initially around lower-price per-unit commodities such as movies, which the serious hacker has multiple avenues to obtain, the economic advantage of attacking the system is reduced to almost zero.

e) either classic principles of trust, or more modern cryptographic principles, can govern mid-transaction states involving a Party C which accepts a secret from Party B for payment of some good or service. In the latter example, the secret may never be “in the clear” at Party C's site, for example. In other words . . . all manner of classic trust and encryption principles can be wrapped around basic transactions, including third party transfers of secrets without knowledge of Party A, provided the new receiver of the secret, Party D, trusts that party B will relinquish all trace/knowledge of the secret.

f) ultimate redemption of the secret can take any classic form.

g) secrets can have additional identification information attached, or none at all.

Having described and illustrated the principles of my invention with reference to a preferred embodiment, it will be apparent that the invention can be modified in arrangement and details without departing from such principles. Accordingly, I claim as my invention all such modifications as may come within the scope and spirit of the following claims, and equivalents thereto.

I claim:

1. A method for internet distribution of video comprising:
displaying to a consumer a listing of video titles;
receiving a signal indicative of a video title selected by the user;
exchanging a fee;
watermarking the video on-the-fly; and
transmitting the video to the consumer.

2. The method of claim 1 in which the watermarking includes watermarking the video with at least one data from the list comprising: an identifier of the date, an identifier of an internet site from which the selected video is provided, an identifier of the consumer, and an identifier of an internet address to which the selected video is transmitted.

3. The method of claim 2 which includes watermarking the video with at least two data from said list.

4. The method of claim 2 which includes watermarking the video with at least three data from said list.

5. The method of claim 2 which includes watermarking the video with all four data from said list.

6. The method of claim 2 in which the watermarking includes watermarking with an identifier of the date.

7. The method of claim 2 in which the watermarking includes watermarking with an identifier of an internet site from which the selected video is provided.

8. The method of claim 2 in which the watermarking includes watermarking with an identifier of the consumer.

9. The method of claim 2 in which the watermarking includes watermarking with an identifier of an internet address to which the selected video is transmitted.
